(19) United States
(12) Patent Application Publication
(10) Pub. No.: US 2017/0087991 A1
(43) Pub. Date: Mar. 30, 2017

(54) NON-RAIL BOUND VEHICLE WITH A LATERALLY PIVOTABLE SLIDING STRIP ARRANGEMENT OF A CURRENT COLLECTOR

(71) Applicant: SIEMENS AKTIENGESELLSCHAFT, MUENC HEN (DE)

(72) Inventors: FLORIAN BUEHS, BERLIN (DE); FRANK GERSTENBERG, BERLIN (DE); MICHAEL LEHMANN, ERLANGEN (DE); GOERAN SAENGER, BERLIN (DE)

(21) Appl. No.: 15/278,255

(22) Filed: Sep. 28, 2016

(30) Foreign Application Priority Data
Sep. 28, 2015 (DE) 10 2015 218 579.6
Oct. 26, 2015 (DE) 10 2015 22 868.0

(51) Int. Cl. B60L 5/08; B60Q 9/00; B60L 5/10; B60L 5/14

(52) U.S. Cl. CPC B60L 5/08; B60L 5/14; B60Q 9/00; B60L 5/10

(57) ABSTRACT

A non-rail bound, electrically or hybrid-electrically driven vehicle has a current collector for feeding electric traction energy from an overhead line system. The current collector has a sliding strip that is brought into sliding contact with a contact wire of the overhead line system above a travel lane. The sliding strip arrangement is pivotable transversely to a direction of travel. The vehicle has a limiter to at least unilaterally limit the transverse pivoting range of the sliding strip arrangement substantially to the width of the vehicle. A driver assistance system assists a driver in adhering to a virtual track within the marked lane. The track width and the pivoting range are dimensioned such that, when the track is adhered to, it is possible to maintain sliding contact between the sliding strip arrangement and the contact wire.

### CROSS-REFERENCE TO RELATED APPLICATION

This application claims the priority, under 35 U.S.C. §119, of German patent applications DE 10 2015 218 579.6, filed Sep. 28, 2015 and DE 10 2015 220 868.0, filed Oct. 26, 2015; the prior applications are herewith incorporated by reference in their entirety.

### BACKGROUND OF THE INVENTION

### Field of the Invention

The invention relates to a non-rail bound vehicle, such as an electrically or hybrid-electrically driven vehicle, comprising a current collector for feeding electric traction energy from an overhead line system. The current collector comprises a liftable and lowerable sliding strip arrangement, wherein the sliding strip arrangement can be brought into sliding contact with a contact wire of the overhead line system extending over a lane and wherein, to maintain the sliding contact in the case of steering movements, the sliding strip arrangement is pivotable transversely to a direction of travel.

A vehicle of this kind is described, for example, in the commonly assigned U.S. Pat. No. 9,346,361 B2 and its counter-art German published patent application DE 10 2011 076 623 A1. It comprises a vehicle body having the width of the vehicle and a current collector for feeding traction energy from a two-pole overhead line. The current collector comprises two support arms the overhead-line ends of which are connected in a hinged manner to a crossbar lying transversely to a longitudinal axis of the vehicle. The crossbar bears a sliding strip arrangement in the form of two rockers mounted rotatably about an axis of the crossbar each comprising two contact strips arranged one behind the other. The vehicle-side ends of the support arms are hinged to the vehicle body such that the sliding strip arrangement is vertically adjustable between a lowered resting position and a raised contact position and can be swiveled between two lateral deflected positions transverse to the longitudinal axis of the vehicle. An actual position of the vehicle relative to the contact wires is acquired by way of a position sensor that is embodied as a video camera permanently installed in the vehicle. The vehicle comprises a closed-loop control facility that determines a set point variable from a comparison of the actual position acquired with a predefined target position of the vehicle relative to the contact wires. The control facility uses the determined set point variable to control a positioning drive for the lateral displacement of the sliding strip arrangement.

Due to the predefined safety margin between the contact wires embodied as forward and return conductors of the overhead line and extending substantially parallel to one another and the predefined minimum length of the contact strips for forming a sufficient working range for them to maintain contact with the contact wires, the known current collector as such has a current collector width which is much greater than the maximum permissible width of the vehicle of the vehicle body of 2.55 m without wing mirrors. An electrified lane of a roadway, for example, the outside lane of a multilane highway can be up to 3.75 m wide. In order to enable the vehicle to maintain contact with the overhead line over the entire lane, the sliding strip arrangement must be able to swing out way beyond the width of the vehicle at both sides so that there is a risk of collision with oncoming traffic, with overtaken and overtaking vehicles and with the infrastructure, in particular with masts and poles standing too close to the edge of the roadway.

### BRIEF SUMMARY OF THE INVENTION

It is accordingly an object of the invention to provide a non-rail bound vehicle which overcomes the above-mentioned and other disadvantages of the heretofore-known devices and methods of this general type and which provides for such a vehicle with increased operational safety with respect to the risk of collision of its current collector.

With the foregoing and other objects in view there is provided, in accordance with the invention, a non-rail bound, electrically or hybrid-electrically driven vehicle, comprising:

a current collector for feeding electric traction energy from an overhead line system to the vehicle;

said current collector including sliding strip arrangement mounted to be liftable and lowerable and to be selectively brought into sliding contact with a contact wire of the overhead line system extending over a travel lane, said sliding strip arrangement being mounted for pivoting transversely to a direction of travel in order to maintain the sliding contact in the case of steering movements of the vehicle;

a limiting device configured to limit a pivoting range of said sliding strip arrangement in the transverse direction substantially to a width of the vehicle;

a driver assistance system for assisting a driver of the vehicle in adhering to a virtual track lying within a marked lane and having a smaller track width than the travel lane;

wherein the track width and the pivoting range are dimensioned such that, when the track is adhered to, sliding contact is maintained between said sliding strip arrangement and the contact wire of the overhead line system.

In other words, the objects of the invention are achieved in that the sliding strip arrangement of the current collector may be lifted to be brought into sliding contact with a contact wire in the overhead line system extending above a lane. In order to maintain the sliding contact with steering movements, the sliding strip arrangement can be pivoted transverse to the direction of travel. According to the invention, the vehicle comprises limiting means for the at least unilateral transverse limitation of the pivoting range of the sliding strip arrangement substantially to the width of the vehicle. The limiting means are preferably formed from a physical stop for the limitation of the pivoting range. Depending upon the embodiment, the pivoting range can be limited in one direction only or in both directions. The vehicle according to the invention also comprises a driver assistance system for assisting a driver in adhering to a virtual track, which lies within the marked lane and has a smaller track width than the lane. In this context, the track width and the pivoting range are dimensioned such that, when the track is adhered to, sliding contact between the sliding strip arrangement and the contact wire can be maintained. The driver assistance system induces the driver to drive on a virtual track within the electrified lane which has a smaller width than the lane. The lane width is designed for a style of driving without a driver assistance system, but the track that can be adhered to with a driver assistance system can be predefined as less wide. This ensures that the vehicle executes less intense sideways deviations during travel with respect to the overhead line. This enables lateral limitation of the pivoting range of the current collector without the possibility of loss of contact from the overhead line as long as the vehicle is held in the virtual track. It is also possible to reduce the width of the sliding strip arrangement of the current collector compared to that of known current collectors, for example to the mirror width of the vehicle. The contact wires of the two-pole overhead line system extend, for example, parallel and symmetrical to the center of the lane, but to minimize wear on the sliding strip arrangement, can also be arranged in a zigzag pattern.

### DETAILED DESCRIPTION OF EXEMPLARY EMBODIMENTS

In one advantageous embodiment of the vehicle according to the invention, the virtual track is positioned more closely to a first side marking of the lane than to its second side marking, wherein the lateral pivoting range of the sliding strip arrangement is limited to the side of the vehicle assigned to the first side marking. For example, if the left lane of a highway is electrified, with masts of the overhead line system being located very close to the left side marking of the lane and hence representing a risk of collision, the virtual track can be located off-center to the left of lane so that the driver assistance system forces the driver to drive left of center at all times. In this context, the pivoting range of the current collector on the left is limited to the mirror width and on average is swung out slightly toward the right. This again results in a working range of contact strips with uniform wear in both directions. Therefore, contrary to the intuitive reaction to keep away from the danger zone, it is suggested in this exemplary embodiment that the danger region should be approached. The strict limitation of the leftward movement reduces the risk of collision. A driver sitting on the left side of the vehicle is able to assess lateral distances of his vehicle from obstacles on the left very accurately and guide the vehicle accordingly. On the other hand, it would optionally even be possible to extend the pivoting range of the current collector on the right.

With the vehicle according to the invention, the lateral pivoting range of the sliding strip arrangement can preferably be additionally limited such that the sliding strip arrangement does not swing beyond the second side marking of the lane. This ensures that the pivoting range toward the right available to the current collector—as described in the above example—is extended without there being any risk of collision with an object standing or driving on the adjacent lane to the right.

In a further advantageous embodiment of the vehicle according to the invention, the width and/or lateral position of the virtual track within the lane and/or the lateral limitation of the pivoting movement of the sliding strip arrangement can be predefined variably as a function of the current position of the vehicle. Restrictions to the utilization of the lane and limitations to the pivoting range can be restricted to locations or segments of the route where this is actually necessitated by obstacles to the side of the lane and it necessary to avoid too short a distance therefrom. For example, obstacles along an electrified route may occur at irregular distances on alternating sides of the lane in each case requiring a change to the virtual track and the limitation of the pivoting range.

In one preferred embodiment, the vehicle sensor according to the invention comprises means for the detection of a lateral deviation from the travel path from the center of the virtual track, wherein the driver assistance system comprises output means for outputting driver information on the deviation from the travel path. The sensor means can detect the current lateral deviation of the vehicle from the center of the track directly or indirectly and supply this deviation from the travel path to the driver assistance system in order to output visual, audible and or tactile driver information via suitable output means. Visual output means take the form of a display on a screen or indicator lamps on the instrument panel of the vehicle. Audible output means can take the form of loudspeakers through which voice notifications or signals can be emitted. Tactile output means can take the form of vibration generators in the steering wheel or driver's seat in the vehicle. The driver information can be a warning issued when the vehicle is in critical proximity to a lateral limitation of the virtual track, for example when a predefined distance threshold to the lateral limitation of the track is fallen below.

Preferably, the output means of the driver assistance system of a vehicle according to the invention are embodied to output varying driver information as a function of the degree of the deviation from the travel path. The driver information can be issued all the more forcibly the closer the vehicle deviates from the center of the track toward a lateral limitation of the virtual track. For example, the warning to the driver can be graduated by increasing volume intensity, light intensity or vibration intensity, by increasing repetition frequency of sound signals, light signals or vibration signals, by changes in color, pitch or vibration frequency or alternating contents of voice notifications or screen displays. As a result, the more there is a risk of leaving the virtual track, the more forcibly the driver is induced to undertake a necessary steering movement.

In one preferred embodiment of the vehicle according to the invention, the output means comprise loudspeakers arranged on both sides of the vehicle and are embodied to output the driver information via loudspeakers on the side of the vehicle in the direction of the detected deviation from the travel path. This enables the driver to receive the driver information output in a particularly intuitive way and convert it into a corresponding steering movement. This type of side-dependent output is also possible for driver information in a visual or tactile form.

In one advantageous embodiment of the vehicle according to the invention, the sensor means are embodied to detect the current lateral deviation from the travel path from the relative position of the vehicle with respect to the facilities of the overhead line system. Most suitable for this are the long-range sensors arranged on the vehicle body and/or the close-range sensors arranged on the current collector for the detection of the contact wires. If the virtual track is predefined with respect to the contact wires of the overhead line system, it is possible to use the relative position of the vehicle with respect to the contact wires to draw conclusions regarding a deviation of the travel path of the vehicle from the center of the track. The virtual track can also be defined by known positions of masts and cross arms in the overhead line system. The virtual track can also be defined by active or passive markings, additional markings or objects with a fixed relationship to the overhead line system.

In a further advantageous embodiment of the vehicle according to the invention, the sensor means are embodied to detect the current lateral deviation from the travel path from the relative position of the vehicle with respect to side markings of the lane. In particular video, radar and lidar sensors can detect the lane markings with respect to which the virtual track can be defined. In this way, the position of the vehicle acquired with respect to the markings of the lane enables the determination of the deviation from the travel path of the vehicle within the virtual track.

The sensor means can also comprises acceleration sensors on the vehicle and/or rotational speed sensors on the tires of the vehicle and use electronic map data and position signals from satellite navigation systems for the determination of the deviation from the travel path.

In a further preferred embodiment of the vehicle according to the invention, the sliding strip arrangement comprises laterally protruding insulating horns with a rupture joint. Insulating horns are arranged as an extension of the contact strips at the lateral ends of the contact strip holders and bent obliquely downward with respect to the course of the contact strip. Just like a folding wing mirror, an insulating horn that has broken off at the rupture joint prevents more extensive damage to the sliding strip arrangement in the event of a collision and hence increases the operational safety of the vehicle.

Preferably, the sliding strip arrangement of the current collector of a vehicle according to the invention comprises a detection facility embodied to detect the breaking-off of an insulating horn and to trigger the automatic lowering of the sliding strip arrangement. In the case of a collision with the breakage of an insulating horn, this ensures that the driver is aware of the collision and does not simply drive on; instead the current collector with the sliding strip arrangement is lowered into a safe resting position. To this end, the air duct in the automatic emergency lowering system can be connected to the emergency lowering system up to the rupture joint and hence initiate the emergency lowering via the safety relay.

In a further preferred embodiment of the vehicle according to the invention, an insulating horn is secured by an arrester cable. In order to increase the operational safety still further, an insulating horn that has broken off is not allowed to fall onto the roadway, but is suspended secured on an arrester cable.

Overall, all the measures result in a high probability that the vehicle will not leave the virtual track and hence that contact with the overhead line will be maintained. In this context, the current collector with the sliding strip arrangement swings out to the side to the lowest degree possible. Preferably, the elements of the roadway and overhead line infrastructure that are already provided are used for the position detection for the determination of the current deviation from the travel path. The invention does not actively intervene in the steering movement. In the event of doubt, the current collector is automatically removed. This enables a dangerous wide lateral swinging out of the current collector toward the sides.

Other features which are considered as characteristic for the invention are set forth in the appended claims. Although the invention is described herein as embodied in a non-rail bound vehicle, it is nevertheless not intended to be limited to the exemplary details. Various modifications and structural changes may be made therein without departing from the spirit of the invention and within the scope and range of equivalents of the claims.

1. A non-rail bound, electrically or hybrid-electrically driven vehicle, comprising:
a current collector for feeding electric traction energy from an overhead line system to the vehicle;
said current collector including sliding strip arrangement mounted to be liftable and lowerable and to be selectively brought into sliding contact with a contact wire of the overhead line system extending over a travel lane, said sliding strip arrangement being mounted for pivoting transversely to a direction of travel in order to maintain the sliding contact in the case of steering movements of the vehicle;
a limiting device configured to limit a pivoting range of said sliding strip arrangement in the transverse direction substantially to a width of the vehicle;
a driver assistance system for assisting a driver of the vehicle in adhering to a virtual track lying within a marked lane and having a smaller track width than the travel lane;
wherein the track width and the pivoting range are dimensioned such that, when the track is adhered to, sliding contact is maintained between said sliding strip arrangement and the contact wire of the overhead line system.

2. The vehicle according to claim 1, wherein the limiting device is configured to limit the lateral pivoting range of said sliding strip arrangement laterally to both sides.

3. The vehicle according to claim 1, wherein the virtual track is positioned more closely to a first side marking of the lane than to a second side marking thereof, and wherein the lateral pivoting range of said sliding strip arrangement is limited to a side of the vehicle assigned to the first side marking.

4. The vehicle according to claim 3, wherein the lateral pivoting range of said sliding strip arrangement is additionally limited such that said sliding strip arrangement does not swing beyond the second side marking of the lane.

5. The vehicle according to claim 1, wherein a width and/or a lateral position of the virtual track within the lane and/or the lateral limitation of the pivoting movement of said sliding strip arrangement is variably defined as a function of a current position of the vehicle.

6. The vehicle according to claim 1, further comprising a sensor for detecting a lateral deviation of a travel path from a center of the virtual track, and wherein said driver assistance system includes an output device configured to output driver information on the deviation from the travel path.

7. The vehicle according to claim 6, wherein said output device is configured to output varying driver information as a function of a degree of the deviation from the travel path.

8. The vehicle according to claim 6, wherein said output device comprises loudspeakers arranged on both sides of the vehicle and configured to output the driver information via the respective loudspeakers on a side of the vehicle in the direction of the detected deviation from the travel path.

9. The vehicle according to claim 6, wherein said sensor is configured to detect the current lateral deviation from the travel path from a relative position of the vehicle with respect to facilities of the overhead line system.

10. The vehicle according to claim 6, wherein said sensor is configured to detect the current lateral deviation from the travel path from a relative position of the vehicle from side markings of the travel lane.

11. The vehicle according to claim 1, wherein said sliding strip arrangement comprises laterally protruding insulating horns with a rupture joint.

12. The vehicle according to claim 11, wherein said sliding strip arrangement comprises a detection facility configured to detect when an insulating horn breaks off and to trigger an automatic lowering of said sliding strip arrangement.

13. The vehicle according to claim 11, wherein an insulating horn is secured by an arrester cable.
